(19) United States
(12) Patent Application Publication
(10) Pub. No.: US 2010/0280937 A1
(43) Pub. Date: Nov. 4, 2010

(54) METHOD AND SYSTEM FOR CREATING AND TRADING MORTGAGE-BACKED SECURITY PRODUCTS

(76) Inventors: John C. Hiatt, JR., Woodridge, IL (US); Dennis M. O'Callahan, Evanston, IL (US)

Correspondence Address: BRINKS HOFER GILSON & LIONE, P.O. BOX 10395, CHICAGO, IL, 60610, US

(21) Appl. No.: 12/772,801

(22) Filed: May 3, 2010

Related U.S. Application Data
(60) Provisional application No. 61/174,829, filed on May 1, 2009.

(51) Int. Cl. G06Q 40/00

(52) U.S. Cl. 705/37

(57) ABSTRACT

A computer-implemented method of creating a derivative investment instrument on an exchange having processor-based equipment is disclosed. The method includes receiving a default rate from a mortgage issuer, the default rate corresponding to a collection of mortgage-backed securities associated with at least one mortgage of the mortgage issuer; associating a risk value with the default rate; creating the derivative investment instrument having a monetary value related to the risk value; and providing, with the processor-based equipment, the derivative investment instrument for trading on an exchange. The method may be stored in a computer-readable memory accessible by the processor-based equipment.

### CROSS-REFERENCE TO RELATED APPLICATIONS

This application claims the benefit of U.S. Provisional Application Ser. No. 61/174,829, filed May1, 2009, of the same title, the entirety of which is hereby incorporated by reference.

### TECHNICAL FIELD

The present disclosure relates to a method and system of creating and trading derivative contracts based on mortgage-backed securities.

### BACKGROUND

Traditional derivatives contracts are well known investment instruments. For example, a buyer purchases the right to receive delivery of an underlying commodity or asset on a specified date in the future. Conversely, a seller agrees to deliver the commodity or asset to an agreed location on the specified date. Derivatives contracts, namely futures contracts, originally developed in the trade of agricultural commodities. Large consumers of agricultural products seeking to secure their future supply of raw ingredients like corn, wheat and other commodities would pay in advance for guaranteed delivery in the future. Producers in turn would sell in advance to raise capital to finance the cost of production. The success of agricultural futures soon led to futures activity surrounding other commodities as well. Today futures contracts are traded on everything from pork bellies to memory chips, and from stock shares to market indices.

Over the years derivatives contracts have evolved from simply a means of securing future delivery of a commodity into sophisticated investment instruments. Because derivatives contracts establish a price for the underlying commodity or asset in advance of the date on which the commodity or asset must be delivered, subsequent changes in the price of the underlying asset will inure to the benefit of one party and to the detriment of the other. If the price rises above the derivatives price, the seller is obligated to deliver the commodity or asset at the lower agreed upon price. The buyer may then resell the received product at the higher market price to realize a profit. The seller in effect loses the difference between the derivatives contract price and the market price on the date the goods or assets are delivered. Conversely if the price of the underlying commodity or asset falls below the derivatives price, the seller can obtain the commodity or asset at the lower market price for delivery to the buyer while retaining the higher price. In this case the seller realizes a profit in the amount of the difference between the current market price on the delivery date and the derivatives contract price. The buyer sees an equivalent loss.

As the preceding discussion makes clear, derivatives contracts lend themselves to speculating in price movements of the underlying commodity or asset. Investors may be interested in taking a “long” position in a commodity or asset, buying today at the present price for delivery in the future, in anticipation that prices for the commodity or asset will rise prior to the delivery date. Conversely investors may wish to take a short position, agreeing to deliver the commodity or asset on the delivery date at a price established today, in anticipation of falling prices.

As derivatives contracts have evolved away from merely a mechanism for securing future delivery of a commodity or asset into sophisticated investment instruments, they have become more and more abstracted from the underlying assets on which they are based. For example, whereas derivatives contracts originally required actual delivery of the underlying commodity or asset on the specified delivery date, today's derivatives contracts do not necessarily require assets to change hands. Instead, derivatives contracts may be settled in cash. Rather than delivering the underlying asset, cash settlement requires that the difference between the market price on the delivery date and the contract price be paid by one investor to the other, depending on which direction the market price has moved. If the prevailing market price is higher than the contract price, the investor who has taken a short position in the derivatives contract must pay the difference between the market price on the delivery date and the contract price to the long investor. Conversely, if the market price has fallen, the long investor must pay the difference between the contract price and the market price to the short investor in order to settle the contract.

Cash settlement allows further abstraction of derivatives contracts away from physical commodities or discrete units of an asset such as stock shares. Today derivatives contracts are traded on such abstract concepts as market indices and interest rates. Derivatives contracts on market indices are a prime example of the level of abstraction such contracts have attained. Delivery of the underlying asset is impossible for a derivatives contract based on a market index such as the S&P 500®. No such asset exists. However, cash settlement allows derivatives contracts to be written which allow investors to take positions relative to future movements in the value of an index, or other variable market indicators. A price is established based on a target value of the index on a specified “delivery” date. The difference between the target value price and the actual value of the index (often multiplied by a specified multiplier) is exchanged between the long and short investors in order to settle the contract. Traditionally, cash settlement occurs on the last day of trading for a particular contract. Thus, if the actual value of the index rises above the target value, the short investor must pay to the long investor an amount equal to the difference between the actual value and the target value times the specified multiplier. Conversely if the actual index value falls below the target value, the long investor must pay to the short investor the difference between the actual value and the target value multiplied by the multiplier.

Mortgage backed securities (MBS) are asset-backed securities or debt obligations that represent a claim on the cash flows from mortgage loans, most commonly on residential property. The market of MBS may be in the trillions of dollars in the U.S. The credit risk of mortgage-backed securities depends on the likelihood of the borrower paying the promised cash flows (principal and interest) on time. It would be advantageous to be able to hedge against the credit risks associated with MBS.

### SUMMARY

In order to provide a hedge against the risks associated with MBS, a derivative instrument based on MBS or other asset based security is disclosed herein. According to a first aspect, a computer-implemented method of creating a derivative investment instrument on an exchange having processor-based equipment, including receiving a default rate from a mortgage issuer, the default rate corresponding to a collection of mortgage-backed securities associated with at least one mortgage of the mortgage issuer; associating a risk value with the default rate; creating the derivative investment instrument having a monetary value related to the risk value; and providing, with the processor-based equipment, the derivative investment instrument for trading on the exchange.

In another aspect of the invention, a computer-readable memory comprising processor executable program instructions for executing the steps of receiving a default rate from a mortgage issuer, the default rate corresponding to a collection of mortgage-backed securities associated with at least one mortgage of the mortgage issuer; associating a risk value with the default rate; creating the derivative investment instrument having a monetary value related to the risk value; and providing, with processor-based equipment, the derivative investment instrument for trading on an exchange.

### BRIEF DESCRIPTION OF THE DRAWINGS

FIG. 1 is an illustrative embodiment of a computer system that used for executing a method of creating a derivative investment instrument on an exchange system.

### DETAILED DESCRIPTION

The present disclosure relates to a financial instrument in which investors may take positions to address certain risks that holders of mortgage-related securities face, such as default and prepayment risk.

To develop exchange-traded products based on mortgage-backed securities, the disclosure presents products that both decompose the risks and increase the transparency in the opaque mortgage marketplace. It also presents an avenue to form partnerships with key players in this market.

Chicago Board Options Exchange (CBOE), perhaps with Standard & Poor's, approach prominent national and/or regional mortgage lenders that issue non-agency (aka “private-label”) asset-backed securities to jointly create risk factor indexes based on these securities. Following are proposed product types (contract specifications are appended to this document):

Physical delivery options that settle to price of the index.

Cash-settled options that settle to the default/delinquency rates of the index.

Cash-settled options that settle to the prepayment rates of the index.

For example, one index might be based on seasoned fixed rate mortgages originated with 30 years to maturity and issued by Wells Fargo. Rules-based criteria would be developed to ensure that the index reflects intended characteristics, for example seasoned fixed-rate mortgages with weighted average maturities between five and seven years with an original mortgagor FICO scores of at least 650, etc. Constructing an index based on individual mortgage lenders has several advantages. First, since these banks frequently also serve as the originator and servicers of MBS they issue, they have authoritative information about the prepayment and default rates on the mortgages covered in the pool. Second, while bank lending practices vary across banks, it is expected that variation within banks is lower since lending standards are probably determined from a top-down approach, and changes to these standards are likely to be more uniform throughout the mortgage lending pipeline. Products that hedge or arbitrage the different products could also be developed similarly.

Following are prominent mortgage lenders that have created substantial private-label (“non-agency) asset-backed pools:

J. P Morgan (J. P. Morgan Acceptance Corporation)

Bank of America (Merrill Lynch Mortgage Investors, Inc.)

Wells Fargo (Wells Fargo Mortgage Backed Securities Trust)

Morgan Stanley (Morgan Stanley ABS Capital)

Citigroup (Citigroup Mortgage Loan Trust Inc.)

Goldman Sachs (GS Mortgage Securities Corp.)

PNC (PNC Mortgage Securities Corp.)

At the same time, we could look to list physical delivery options on the more active pools of agency securities and options on the prepayment rates for these pools since these address investor exposures in this sector. As this market unfolds we could also list products based on other asset-backed securities such as credit card receivables, etc.

Currently there are several initiatives that allow investors to gain exposure to the more secure tranches of mortgage-backed securities. For example, with the iShares Barclays MBS Bond Fund (MBB) investors can gain access to the investment grade agency mortgage-backed security. Likewise Invesco has filed to list ETFs based on agency and the most default remote tranches for non-agency mortgage backed securities through its Powershares unit.

Neither the iShares nor the Powershares funds adequately address some of the risks that investors in this sector incur, namely prepayment and default risk, because they focus on the prices of the securities of the safest tranches. Moreover, it can be argued this is where there is the least concern to investors since these are the CMO tranches where transparency is highest and liquidity is strongest. Note that Invesco and Horizon Asset Management have independently proposed ETF-based proposals to address the lower credit tier classes of the MBS market that are intended to dovetail with Treasury Secretary Geithner's launch of the Public-Private Partnership Investment Program (PPPIP). While the ETF-based proposals appear to focus more on the current market issues, the CBOE proposal can be used in the current environment and also to address mortgage-related (and other asset-backed security) risks on an ongoing basis.

Market Participants

Following is a summary of market participants in the MBS:

Originators and Servicers. Commercial banks, thrift institutions, and credit unions originate most mortgage loans. While many of these mortgages historically have been sold to Fannie Mae and Freddie Mac or sold to vehicles that issue MBS with GNMA's U.S. full faith guarantee, at least some portion are usually held by the lenders either as whole loans or pooled into private label MBS. If these mortgages are held by the lender, the lender is exposed to credit and prepayment risks. If the lender pools these mortgages into private label multi-class MBS, the issuer must introduce some form of credit enhancement to induce investors to hold the securities. In both these cases where the mortgages are held or issued as MBS by the lender, prepayment and default option products may be attractive.

Poolers. Ginnie Mae, Fannie Mae, and Freddie Mac back the issuers Agency MBS with their respective guarantees (which may be identical since Fannie Mae and Freddie began operating under the conservatorship of the U.S.). It is possible that exchange-traded prepayment and default option products may lessen the taxpayer cost of their guarantees.

Dealers/Market Makers. Dealers facilitate placement MBS in the secondary mortgage market and make markets in off-the-run issues to allow investors to exit and enter the market. At any point in time they are likely to have price, prepayment and default exposures.

Bond Insurers. As stated earlier, issuers of private-label multi-class MBS frequently buy insurance from a bond insurer (e.g., MBIA or Primus) as a credit enhancement to place these securities with investors. The insurer commits to make interest and principal payments on a tranche of the MBS issue if the issuer is unable to do so. Bond insurers have been on the hot seat in the recent credit crisis as their ability to insure MBS and other debt securities has fallen precipitously. Mortgage bond insurers are natural purchasers of default options.

Investors. Banks, insurance companies, hedge funds, mutual funds, foreign central banks, and sovereign wealth funds are the largest investors in both private label and Agency MBS. (Note: many investors have shied away from private label MBS since there has been a high degree of skepticism in the integrity of this market.) Investors wishing to gain exposure to mortgage assets have a strong incentive to hold highly rated MBS since they receive much better capital treatment over whole loans under current capital rules. Since the higher rated classes have higher exposure to prepayment risk, these institutional investors may have strong interest in products to hedge prepayment risk. To create the multi-class private label MBS, however, lower rated tranches must be created and sold. Hedge funds and other sophisticated investors that purchase these lower rated tranches may have interest in products to hedge their default risk.

Table 1 below shows reportable holdings for one of the larger mortgage-backed security ETFs, the $1.4 billion iShares Barclays MBS Bond Fund. As one would expect, major fund managers Credit Suisse, Merrill Lynch, Lazard Asset Management, UBS, Citigroup and Morgan Stanley are large holders of the iShares Barclays MBS Bond Fund. Also noteworthy is that National City, a mortgage originator, appears as one of the largest holders as does Jane Street, perhaps tied to their market making in the listed options on the ETF. Note again that this fund holds only investment grade mortgage-backed pass-through securities issued by the Government National Mortgage Association “(GNMA”), Federal National Mortgage Association (“FNMA”) and Federal Home Loan Mortgage Corporation (“FHLMC”), so it does not show firms wishing to gain exposure to MBS with substantial default risk.

TABLE 1

| | | | | Latest | |
|---|---|---|---|---|---|
| Holder Name | Portfolio Name | Amt Held | % Out | Chg | File Dt |
| 1) Credit Suisse | Credit Suisse/ | 880,192 | 6.38 | 880,192 | Dec. 31, 2008 |
| 2) Curian Capital LLC | Curian Capital LLC | 862,464 | 6.25 | −51,335 | Mar. 31, 2009 |
| 3) Merrill Lynch & Comp | Merrill Lynch & Co | 799,896 | 5.80 | 512,042 | Dec. 31, 2008 |
| 4) Lazard Asset Managem | Lazard Asset Mana | 415,697 | 3.01 | −151,311 | Dec. 31, 2008 |
| 5) UBS Fund Management | UBS (CH) Inst Fund | 336,466 | 2.44 | −16,500 | Feb. 27, 2009 |
| 6) Citigroup Incorporat | Citigroup Incorpo | 195,223 | 1.41 | 59,775 | Dec. 31, 2008 |
| 7) Morgan Stanley & Co | Morgan Stanley | 191,516 | 1.39 | 50,203 | Dec. 31, 2008 |
| 8) Tactical Allocation G | Tactical Allocatio | 187,159 | 1.36 | 97,676 | Dec. 31, 2008 |
| 9) Wachovia Securities, | Wachovia Securitie | 185,376 | 1.34 | 3,232 | Dec. 31, 2008 |
| 10) National City | National City Corp | 181,195 | 1.31 | 26,378 | Dec. 31, 2008 |
| 11) Dal Investment Compa | Dal Investment Co | 134,300 | 0.97 | 134,300 | Dec. 31, 2008 |
| 12) Jane Street Holding L | Jane Street Holdin | 118,849 | 0.86 | 91,795 | Dec. 31, 2008 |
| 13) Wealth Builders Inc | Wealth Builders In | 118,301 | 0.86 | 23,745 | Mar. 31, 2009 |
| 14) Truenorth Inc | Truenorth Inc | 112,550 | 0.82 | 109,410 | Mar. 31, 2009 |
| 15) Synovus Financial Co | Synovus Financial | 92,498 | 0.67 | 92,498 | Dec. 31, 2008 |
| 16) UBS AG | UBS AG | 80,566 | 0.58 | 10,039 | Dec. 31, 2008 |
| 17) Advanced Equities Ass | Advanced Equities | 68,350 | 0.50 | 68,350 | Dec. 31, 2008 |

Index Methodology

Information is electronically available from market data sources, such as Bloomberg, for a private label multi-class MBS trust that Wells Fargo Asset Securities Corp. issued via an entity called Wells Fargo Mortgage Backed Securities 2007-17 in early 2008. For example, the assets held in this trust may be residential, fixed rate mortgages with original maturity of 30 years where over two-thirds of the mortgagors by weight had FICO score over 700 at the time of mortgage origination. Note that Wells Fargo and other private label CMO issuers issue pools that with a menu of characteristics (ARMs, 15-year fixed rate mortgages, credit criteria) on a regular basis. Information on descriptions of the trust and classes of the trust in order of seniority is also available from Bloomberg Finance, L. P.

Default Risk Value

On a monthly basis, the issuer, through its servicer, calculates the defaults of the mortgages that are held by the trust. For example, the payment delinquency rate for the Wells Fargo Mortgage Backed Securities 2007-17 trust from September 2008 through April 2009 as calculated and disseminated by the issuer is the type of information electronically available. While all tranches have some risk of default, investors in the lower tranches have much greater risk, particularly in trusts where the issuer had minimal lending standards like Countrywide. Note that the 60 day or longer delinquency rate for the Wells Fargo 2007-17 trust is only 5.10%; while the analogous rate for one Countrywide trust (CWL 2007-QH1) was 77.71% in April 2009. CBOE may work with the issuer to have access to this delinquency rate or some similar barometer of the default rate of the trust and settle this value.

Prepayment Risk Value

Also on a monthly basis, the issuer determines the prepayments of the mortgages that are held by the trust and disseminates this information electronically. Certain tranches, such as was the case for the A1 in the January 2008 through April 2009 time frame, have very high prepayment risk and investors in these tranches may find options to hedge this risk useful. Note that this information is also made available by the issuer in SEC 8-K filings on a monthly basis, so it is in the public domain. Although it needs to be confirmed independently of any one market data source, such as Bloomberg, the prepayment settlement value for a given month would be that month's “Factor” multiplied by 100 and rounded to two decimals (e.g., April 2009 prepayment settlement value would be 83.40).

The proposed products can be used to address the current overhang of troubled mortgages and can be used once the economy rebounds since aberrations in prepayment rates are a major risk factor for mortgage investors.

The proposed products may be created and traded on processor-based equipment that could be configured, for example, to access information from a mortgage issuer relating to delinquency rate or some similar barometer of the default rate of the trust and settle this value. Separately or in combination, the proposed product could also incorporate valuation and/or settlement factors relating to prepayment risk as noted above. This information may be automatically received and processed to generate appropriate criteria for creating a financial instrument for trading on an automated exchange, and open-outcry exchange, or an exchange combining both screen-based and open-outcry trading.

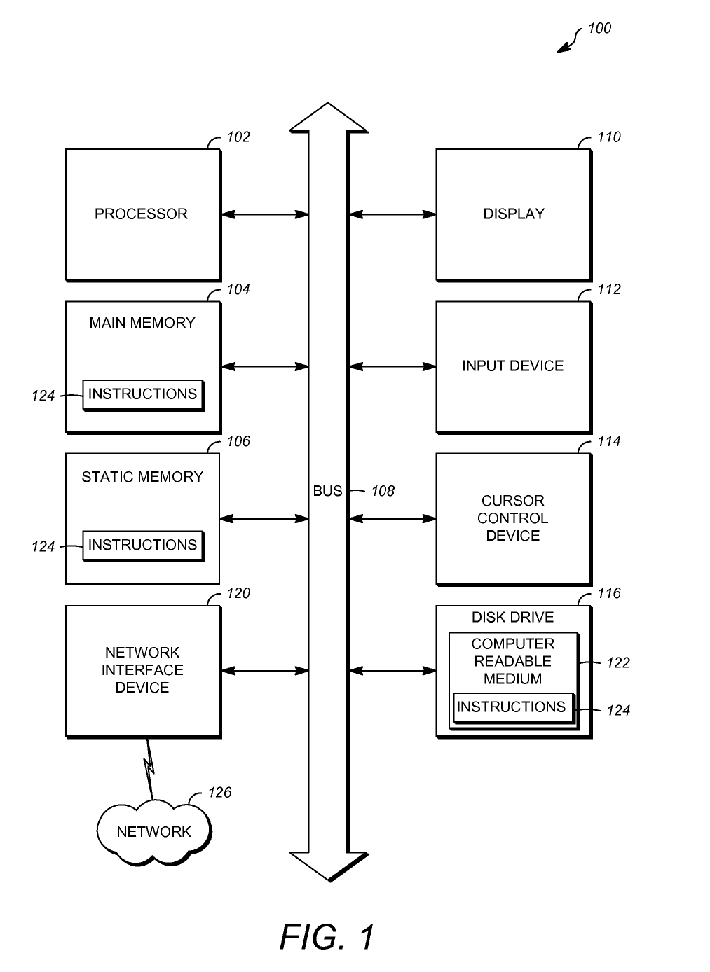

Referring now to FIG. 1, an illustrative embodiment of a general computer system that may be used for executing one or more of the steps of creating or trading a mortgage-backed security, or as part of a trading system or exchange configured to carry out the methods discussed above to create and trade the financial instrument, is shown and is designated 100. The computer system 100 can include a set of instructions that can be executed to cause the computer system 100 to perform any one or more of the methods or computer based functions disclosed herein. The computer system 100 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 102, e.g., a central processing unit (CPU), a graphics processing unit (GPU), or both. Moreover, the computer system 100 can include a main memory 104 and a static memory 106 that can communicate with each other via a bus 108. As shown, the computer system 100 may further include a video display unit 110, such as a liquid crystal display (LCD), an organic light emitting diode (OLED), a flat panel display, a solid state display, or a cathode ray tube (CRT). Additionally, the computer system 100 may include an input device 112, such as a keyboard, and a cursor control device 114, such as a mouse. The computer system 100 can also include a disk drive unit 116 and a network interface device 120.

In a particular embodiment, as depicted in FIG. 1, the disk drive unit 216 may include a computer-readable medium 122 in which one or more sets of instructions 124, e.g. software, can be embedded. Further, the instructions 124 may embody one or more of the methods or logic as described herein. In a particular embodiment, the instructions 124 may reside completely, or at least partially, within the main memory 104, the static memory 106, and/or within the processor 102 during execution by the computer system 100. The main memory 104 and the processor 102 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data information that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 124 or receives and executes instructions 124 responsive to a command or other trigger event, so that a device connected to a network 126 can communicate voice, video or data over the network 126. Further, the instructions 124 may be transmitted or received over the network 126 via the network interface device 120.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols commonly used on financial exchanges, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

1. A computer-implemented method of creating a derivative investment instrument on an exchange having processor-based equipment, comprising:
receiving a default rate from a mortgage issuer, the default rate corresponding to a collection of mortgage-backed securities associated with at least one mortgage of the mortgage issuer;
associating a risk value with the default rate;
creating the derivative investment instrument having a monetary value related to the risk value; and
providing, with the processor-based equipment, the derivative investment instrument for trading on the exchange.

2. The method of creating a derivative investment instrument according to claim 1 comprising:
receiving a prepayment risk value from a mortgage issuer, the prepayment risk value corresponding to the collection of mortgage-backed securities associated with the at least one mortgage of the mortgage issuer; and
incorporating the payment risk value in the derivative investment instrument.

3. A computer-readable memory comprising processor executable program instructions for executing the steps of:
receiving default rate from the mortgage issuer, the default rate corresponding to a collection of mortgage-backed securities associated with at least one mortgage of the mortgage issuer;
associating a risk value with the default rate;
creating the derivative investment instrument having a monetary value related to the risk value; and
providing, with a processor-based equipment, the derivative investment instrument for trading on an exchange.

4. The computer-readable memory of claim 3 comprising processor executable program instructions for executing the steps of:
receiving a prepayment risk value from a mortgage issuer, the prepayment risk value corresponding to the collection of mortgage-backed securities associated with the at least one mortgage of the mortgage issuer; and
incorporating the payment risk value in the derivative investment instrument.
